(19) United States
(12) Patent Application Publication
(10) Pub. No.: US 2006/0262232 A1
(43) Pub. Date: Nov. 23, 2006

(54) Video image signal processing apparatus

(76) Inventors: Naoki Kuwajima, Fukaya-shi (JP); Kazuyuki Rikiishi, Fukaya-shi (JP); Takayoshi Mogi, Fukaya-shi (JP); Hiroshi Azami, Chichibu-shi (JP); Takashi Asano, Fukaya-shi (JP); Shota Kida, Fukaya-shi (JP); Masakazu Nakamura, Kumagaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/409,986

(22) Filed: Apr. 25, 2006

(30) Foreign Application Priority Data
Apr. 25, 2005 (JP) 2005-126699

(51) Int. Cl. G06F 1/16; H04N 5/64

(52) U.S. Cl. 348/836; 361/681

(57) ABSTRACT

According to one embodiment, a video image signal processing apparatus includes a device main body which displays a video image that corresponds to a received video image signal, an HDD unit having formed therein an operating piece elastically deformed to enable a push operation of an operating component, a stand supporting the device main body while a video image display screen is erected, and having a housing section which removably houses the HDD unit, and also having an operator which elastically deforms the operating piece at a position opposed to the operating piece of the HDD unit to make the operating component operable.

### CROSS-REFERENCE TO RELATED APPLICATIONS

This application is based upon and claims the benefit of priority from Japanese Patent Application No. 2005-126699, filed Apr. 25, 2005, the entire contents of which are incorporated herein by reference.

### BACKGROUND

1. Field

One embodiment of the invention relates to a video image signal processing apparatus such as a digital television broadcast receiving apparatus, for example.

2. Description of the Related Art

As is well known, in recent years, digitization of a television broadcast has been promoted. For example, there has been started a terrestrial digital broadcast as well as a broadcasting satellite (BS) digital broadcast and a 110-degree communication satellite (CS) digital broadcast.

In addition, in a television broadcast receiving apparatus for receiving a television broadcast, for example, there has been introduced an apparatus having a function for automatically recording a broadcast program based on a genre or a keyword set by a user so that the user can select and view a required program from among the recorded programs.

In this case, a recording and reproducing apparatus for recording and reproducing a broadcast program requires a large recording capacity capable of recording a number of programs. In addition, this apparatus requires access performance capable of speedily retrieving and reproducing a desired program from the recorded programs. Thus, a hard disk drive (HDD) is employed in order to meet these requirements.

In the meantime, in a current television broadcast receiving apparatus, there is a tendency that a low-profile large-screen apparatus becomes prevalent, the apparatus employing a flat panel display composed of a liquid crystal display or a plasma display in its video image display section. In this case, it becomes important to take measure for efficiently mounting an HDD in the apparatus without losing slimming of the television broadcast receiving apparatus.

Here, in both of Jpn. Pat. Appln. KOKAI Publication Nos. 2000-357026 and 2001-5558, in a desk top type personal computer, among a device main body for supporting its liquid crystal display unit, there is disclosed a construction such that a hard disk drive unit is housed in a base section placed on a predetermined placement face.

In addition, in Jpn. Pat. Appln. KOKAI Publication No. 2002-14745, in a personal computer having a liquid crystal display section on a main face of a housing, there is disclosed a construction in which the liquid crystal display section is openably installed in the housing, and a user opens the liquid crystal display section, whereby an HDD can be mounted on an HDD bay provided inside of the housing.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an external view showing an embodiment of the present invention for the purpose of explaining a television broadcast receiving apparatus;

FIG. 2 is a block diagram for explaining a signal processing system of the television broadcast receiving apparatus in the present embodiment;

FIG. 3 is a perspective view for explaining a state in which a stand of the television broadcast receiving apparatus in the present embodiment is seen from a rear side;

FIG. 4 is an external view for explaining an HDD unit housed in the television broadcast receiving apparatus in the present embodiment;

FIG. 5 is a perspective view for explaining a state in which the stand of the television broadcast receiving apparatus in the present embodiment is seen from a rear side;

FIG. 6 is an exploded perspective view for explaining an internal construction of the HDD unit housed in the television broadcast receiving apparatus in the present embodiment;

FIG. 7 is a perspective view for explaining the HDD unit housed in the television broadcast receiving apparatus in the present embodiment;

FIG. 8 is a perspective view for explaining a state in which the HDD unit is housed in the stand of the television broadcast receiving apparatus in the present embodiment;

FIG. 9 is a perspective view for explaining an internal construction of the stand of the television broadcast receiving apparatus in the present embodiment;

FIG. 10 is a plan view for explaining a state in which the HDD unit is housed in the stand of the television receiving apparatus in the present embodiment;

FIG. 11 is a plan view for explaining a state in which the HDD unit is housed in the stand of the television receiving apparatus in the present embodiment;

FIG. 12 is a block diagram for explaining the signal processing system of the television broadcast receiving apparatus in the present embodiment;

FIG. 13 is a perspective view for explaining an operating piece of the HDD unit housed in the television broadcast receiving apparatus in the present embodiment; and

FIG. 14 is a side cross section for explaining a relationship between an operator of the stand and an operating piece of the HDD unit of the television broadcast receiving apparatus in the present embodiment.

### DETAILED DESCRIPTION

Various embodiments according to the invention will be described hereinafter with reference to the accompanying drawings. In general, according to one embodiment of the invention, a video image signal processing apparatus includes: a device main body which displays a video image that corresponds to a received video image signal; an HDD unit having formed therein an operating piece elastically deformed to enable a push operation of an operating component; a stand supporting the device main body while a video image display screen is erected, and having a housing section which removably houses the HDD unit, and also having an operator which elastically deforms the operating piece at a position opposed to the operating piece of the HDD unit to make the operating component operable.

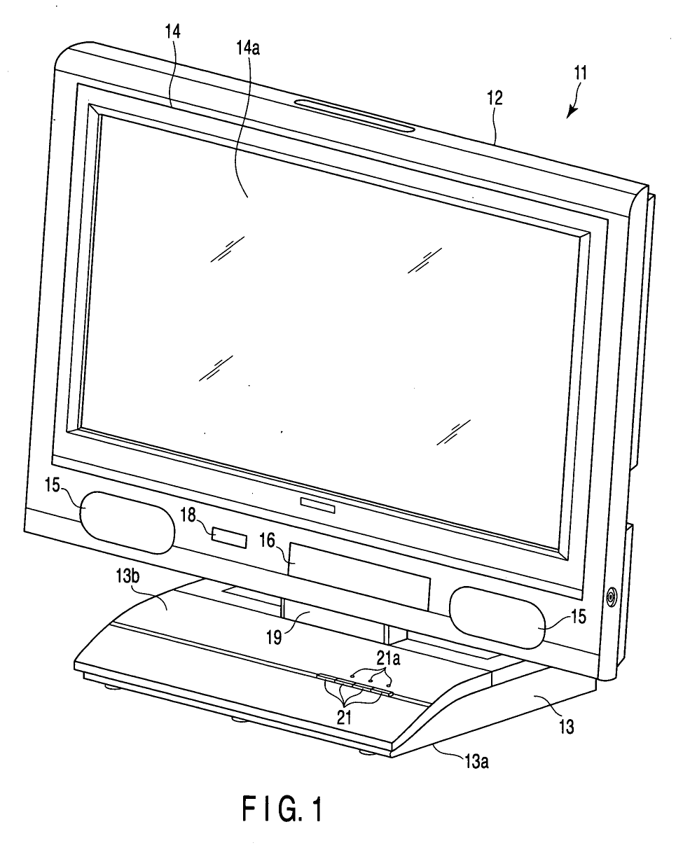

FIG. 1 shows an appearance of a front side of a television broadcast receiving apparatus 11 explained in the present embodiment. That is, this television broadcast receiving apparatus 11 is mainly composed of: a low-profile cabinet 12 formed in a substantial square shape, the cabinet serving as a device main body; and a stand 13 supporting this cabinet 12 while the cabinet is erected.

Then, in the above cabinet 12, a display screen 14a of a video image display 14 made of a flat liquid crystal display panel or the like, for example, is exposed on its front face. In addition, there are allocated a pair of speakers 15, an operating section 16, and a photoreceptor section 18 or the like for receiving operational information transmitted from a remote controller 17 described later (not shown in FIG. 1).

In addition, the above-described stand 13 is formed in a substantially low-profile box shape, and is configured so that a bottom face plate 13a serving as one flat face thereof is placed on a predetermined vertically installed base (not shown). Then, a support member 19 protruding upward from a substantial center part of a top face plate 13b serving as a face opposite to the face placed on the base is coupled with a rear face of the above-described cabinet 12, whereby this stand 13 is supported in a state in which the cabinet 12 is erected.

Here, the above-described stand 13 can house an HDD unit (not shown in FIG. 1) 20 described later therein. Then, on the top face plate 13b of this stand 13, at a portion protruding on a front side from the cabinet 12, there are allocated: a plurality of operators 21 (four operators shown) capable of making a push operation, for controlling the HDD unit 20 in a recording, reproducing, or stop state or the like; and a display section 21a indicating an operating state of each of the operators 21.

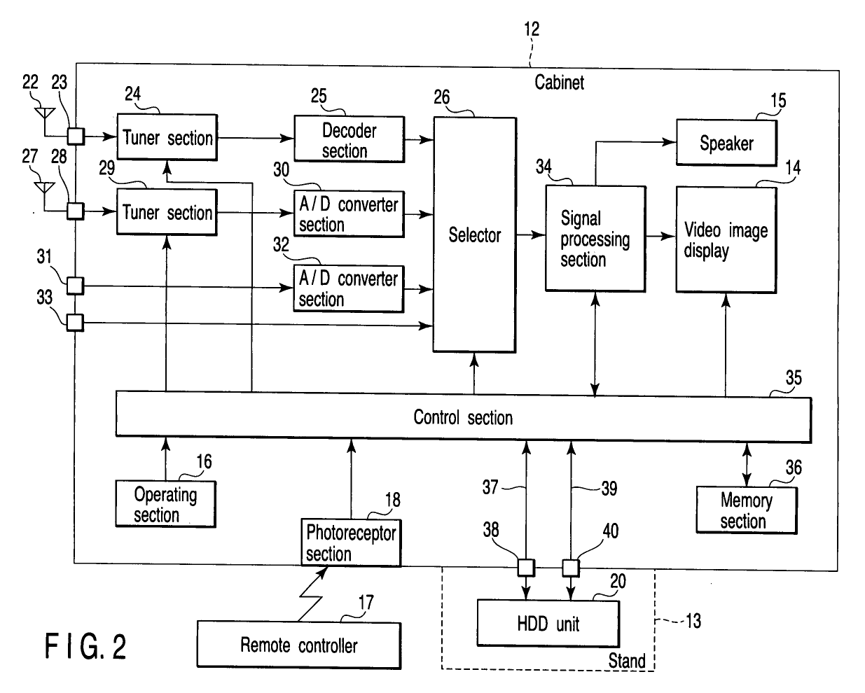

FIG. 2 schematically shows a signal processing system of the above-described television broadcast receiving apparatus 11. A variety of circuit blocks configuring this signal processing system are mainly allocated in location close to a rear face inside of the above-described cabinet 12, namely, near a back side of the display screen 14a of the above-described video image display 14.

Then, a digital television broadcast signal received by an antenna 22 for receiving digital television broadcast is supplied to a tuner section 24 via an input terminal 23. This tuner section 24 selects and demodulates a signal of a desired channel from the inputted digital television broadcast signals. Then, the signal outputted from this tuner 24 is supplied to a decoder section 25, and, for example, an MPEG (moving picture expert group) 2 decoding process is applied. Then, the decoded signal is supplied to a

Further, an analog television broadcast signal received by an antenna 27 for receiving an analog television broadcast is supplied to a tuner section 29 via an input terminal 28. This tuner section 29 selects and demodulates a signal of a desired channel from the inputted analog television broadcast signals. Then, the signal outputted from this tuner section 29 is digitized by means of an analog/digital (A/D) converter section 30, and the digitized signal is outputted to the above-described selector 26.

In addition, analog video image and voice signals supplied to an analog signal input terminal 31 is digitized to be supplied to an A/D converter section 32, and then, the digitized signals are outputted to the above-described selector 26. Further, digital video image and voice signals supplied to a digital signal input terminal 33 are supplied intact to the above-described selector 26.

The above-described selector 26 selects one from among four types of input digital video image and voice signals, and supplies it to a signal processing section 34. This signal processing section 34 applies predetermined signal processing to an inputted digital video image signal so as to display the video image on the above-described video image display 14. As this video image display section 14, for example, there is employed a flat panel display made of a liquid crystal display or a plasma display and the like. In addition, the above-described signal processing section 34 applies predetermined signal processing to an inputted digital voice signal, converts the processed signal into an analog signal, and then, outputs the converted analog signal to the above-described speakers 15, thereby carrying out voice reproduction.

Here, this television broadcast receiving apparatus 11 causes a control section 35 to integrally control a variety of operations including a variety of the above-described receiving operations. This control section 35 is provided as a microprocessor incorporating a central processing unit (CPU) or the like. This control section receives via the photoreceptor section 18 the operational information from the above operating section 16 and the operator 21 (not shown in FIG. 2) or the operational information transmitted from the above-described remote controller 17, thereby controlling each section so that its operation contents are reflected.

In this case, the control section 35 uses a memory section 36. This memory section 36 mainly comprises: a read only memory (ROM) having stored therein a control program that the CPU of the control section executes; a random access memory (RAM) for providing a work area to the CPU; and a nonvolatile memory supplied with a variety of setting information and control information or the like.

Here, the above-described control section 35 is connected to the HDD unit 20 housed in the stand 13. In this case, a line 37 for supplying power and a control signal from the control section 35 to the HDD unit 20 is connected to the control section 35 and the HDD unit 20 via a connecting portion 38.

In addition, a line 39 for carrying out exchange of digital video image and voice signals between the control section 35 and the HDD unit 20 connects the control section 35 and the HDD unit 20 to each other via an i. Link connecting portion 40. That is, transmission of the digital video image and voice signals between the control section 35 and the HDD unit 20 is carried out by the i. Link independently of power and control signals.

In addition, the above-described television broadcast receiving apparatus 11 can record the digital video image and voice signals selected by the selector 26 by means of the HDD unit 20. In addition, this receiving apparatus reproduces the digital video image and voice signals recorded in the HDD unit 20 and can be provided for the purpose of viewing.

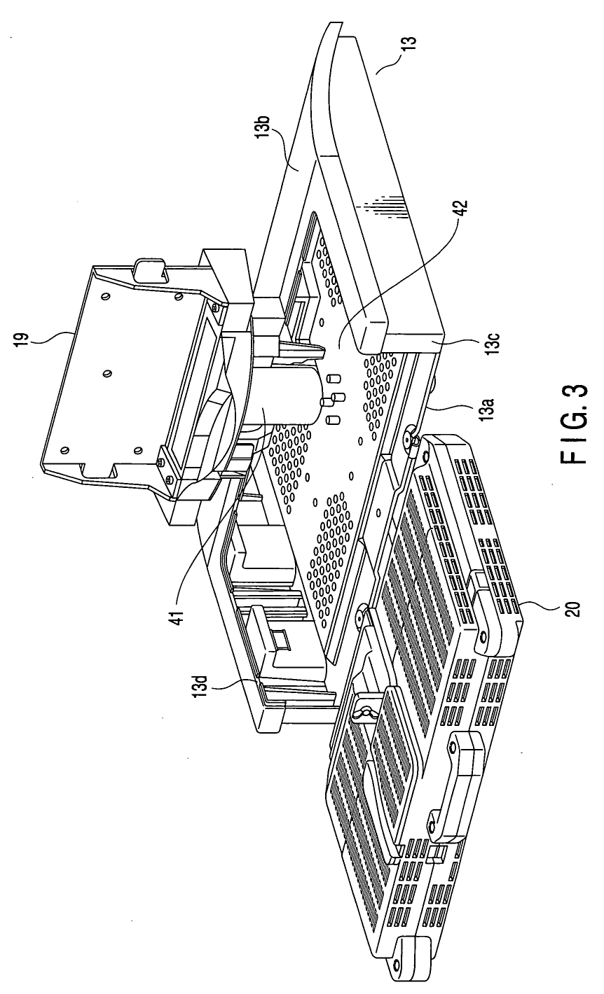

FIG. 3 shows a state in which the above-described stand 13 is seen from a rear side. That is, the stand 13 is formed in a substantially low-profile box shape, as described previously. A majority from its rear plate 13c to the substantial center part of its top plate 13b is continuously opened, whereby a mount/demount port 13d is formed. This mount/demount port 13d can be closed by a cover which is not shown.

A cylindrically shaped support column body 41 is vertically protruded at the substantial center part of a bottom plate 13a of this stand 13. This support column body 41 is protruded at its distal end more upwardly of the top plate 13b via the mount/demount port 13d formed on the top plate 13b. In addition, the support member 19 coupled with the above-described cabinet 12 is mounted on a distal end of this support column body 41.

In addition, the stand 13 is hollowed at a majority of its inside, and serves as a housing section 42 capable of housing the above-described HDD unit 20. In this case, from the outside of the stand 13, the HDD unit 20 is inserted along the bottom plate 13a through the mount/demount port 13d at a rear side of the stand 13, whereby the HDD unit is housed in the stand 13. In addition, the HDD unit 20 housed in the stand 13 can be mounted at the outside of the stand 13 along the bottom plate 13a through the mount/demount port 13d at the rear side of the stand 13.

That is, the HDD unit 20 is housed in the stand 13 so that it can record and reproduce video image and voice signals. In addition, this HDD unit is configured so as to enable mounting/demounting with respect to the stand 13, namely, to enable exchange.

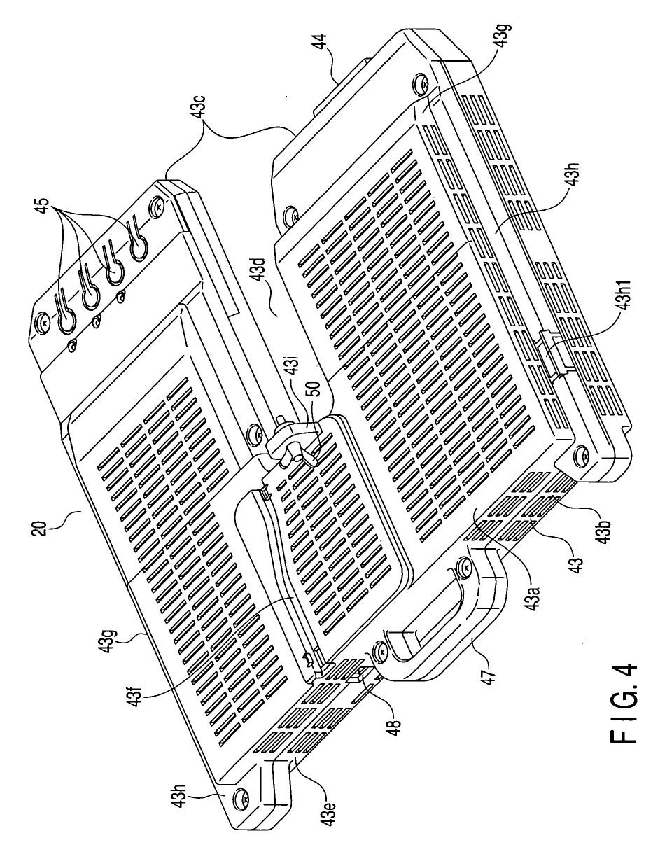

FIG. 4 shows an appearance of the above-described HDD unit 20. This HDD unit 20 comprises a unit case 43 formed in a low-profile box shape, which is housed so as to mostly occupy the inside of the stand 13. This unit case 43 is configured by integrating an upper unit case 43a and a lower unit case 43b with each other.

Then, in this unit case 43, a release section 43d greatly eliminated inwardly from its substantial center part is formed at a front face 42c, namely, a distal end in an insert direction when the unit case is inserted into the stand 13. As a whole, this unit case is formed in a substantial U shape in plane. The release section 43d of this unit case 43 is formed so as to avoid the above-described support column body 41 when the unit case 43 is inserted into the stand 13.

In addition, from among the distal end in the insert direction into the stand 13 of the unit case 43, a connector 44 is installed at a portion that corresponds to the right side of the release section 43d in FIG. 4. This connector 44 corresponds to the connecting portion 38 shown in FIG. 2. This connector is used to receive supply of power and a control signal from the cabinet 12 when the unit case 43 has been housed in the stand 13.

Further, although a detailed description will be given later, from among the distal ends in the insert direction into the stand 13 of the unit case 43, at a portion that corresponds to the left side of the release section 43d in FIG. 4, a plurality of operating pieces 45 (four operating pieces shown) are formed at an upper unit case 43a of the unit case. These operating pieces 45 are formed at positions that correspond to the operators 21 allocated on the top plate 13b of the stand 13 when the unit case 43 has been housed in the stand 13.

These operating pieces 45 each have elasticity by cutting the upper unit case 43 in a tongue shape. These operating pieces relay an operating force of, when the operator 21 is operated to be pushed, elastically deforming the operating piece inwardly of the unit case 43 while it is pushed by the operator 21, and making a push operation of a switch 46 (not shown in FIG. 4) that is an operating component capable of a push operation, the switch being installed in the unit case 43.

In addition, a grip section 47 for drawing out the unit case 43 from the inside of the stand 13 is installed at a rear distal end in the insert direction into the stand 13 of the unit case 43, namely, on a rear face 43e.

Further, an i. Link connector 48 is installed on the rear face 43e of the unit case 43. This i. Link connector 48 corresponds to the i. Link connecting portion 40 shown in FIG. 2. When the unit case 43 is housed in the stand 13, the i. Link connector is used to carry out exchange of video image and voice signals with the cabinet 12.

In this case, a signal line 49 (not shown in FIG. 4) corresponding to the line 39 shown in FIG. 2, the signal line extended from the cabinet 12, is connected to the i. Link connector 48. Then, in the upper unit case 43a, at its planar section, there is formed a guide groove 43f for housing the above-described signal line 49 and guiding the housed signal line to the i. Link connector 48.

In addition, in a direction orthogonal to the insert direction into the stand 13 of the unit case 43, namely, on each one of a pair of side faces 43g in a widthwise direction, there is formed a guide face 43h serving as a guide when the unit case 43 is inserted into the stand 13. This guide face 43h is formed so that the unit case 43 is oriented upwardly when it is inserted into the stand 13 and is oriented along the insert direction.

Further, on this guide face 43h, a plate spring 43h1 is formed close to a rear end in the insert direction into the stand 13 of the unit case 43. This plate spring 43h1, for example, is formed so as to generate a biasing force upwardly than the guide face 43h by cutting the guide face 43h in the tongue shape.

In addition, in the above upper unit case 43a, from among its planer section, a mount piece 43i is formed at a position that corresponds to the deepest location of the release section 43d. A screw 50 is inserted into this mount piece 43i along the insert direction into the stand 13 of the unit case 43. This screw 50 is helically fitted to the support column body 41 in the stand 13 when the unit case 43 is housed in the stand 13, and the unit case 43 is fixed. As this screw 50, there is used a screw of such a type that can be manually turned by a user without using any tool such as a screwdriver.

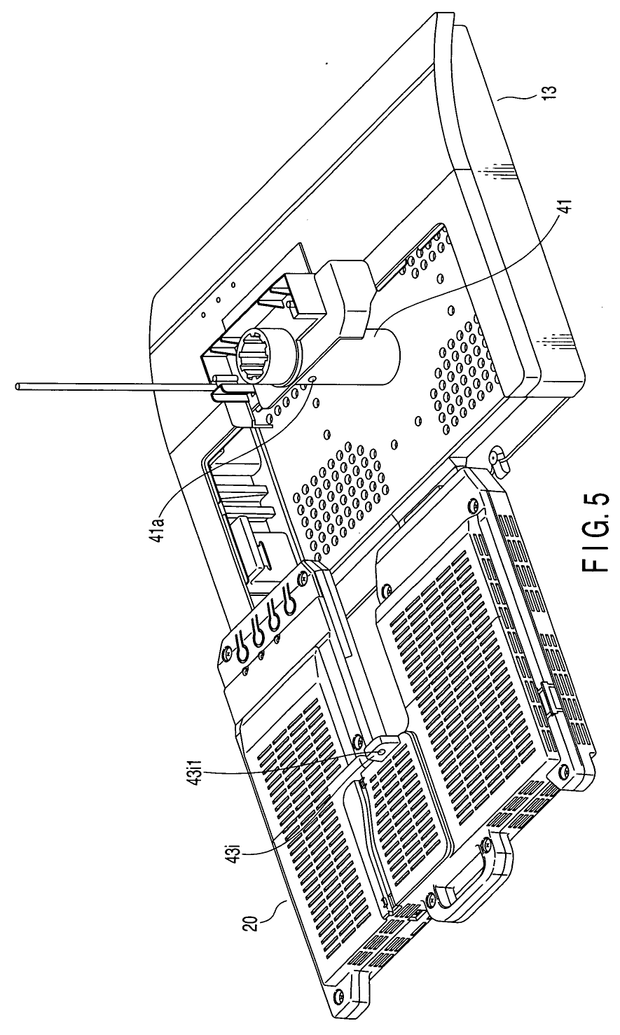

FIG. 5 shows a state in which the above-described stand 13 is seen from a rear side. In comparison, FIG. 5 is different from FIG. 3 in that the support member 19 is demounted from the support column body 41. That is, a through hole 43i1 having the above-described screw 50 inserted thereinto is formed on the mount. piece 43i formed in the upper unit case 43a of the unit case 43. In addition, in the support column body 41, a screw hole 41a having the above-described screw 50 helically fitted thereto when the unit case 43 has been housed in the stand 13 is formed at a position opposite to the through hole 43i1 of the mount piece 43i.

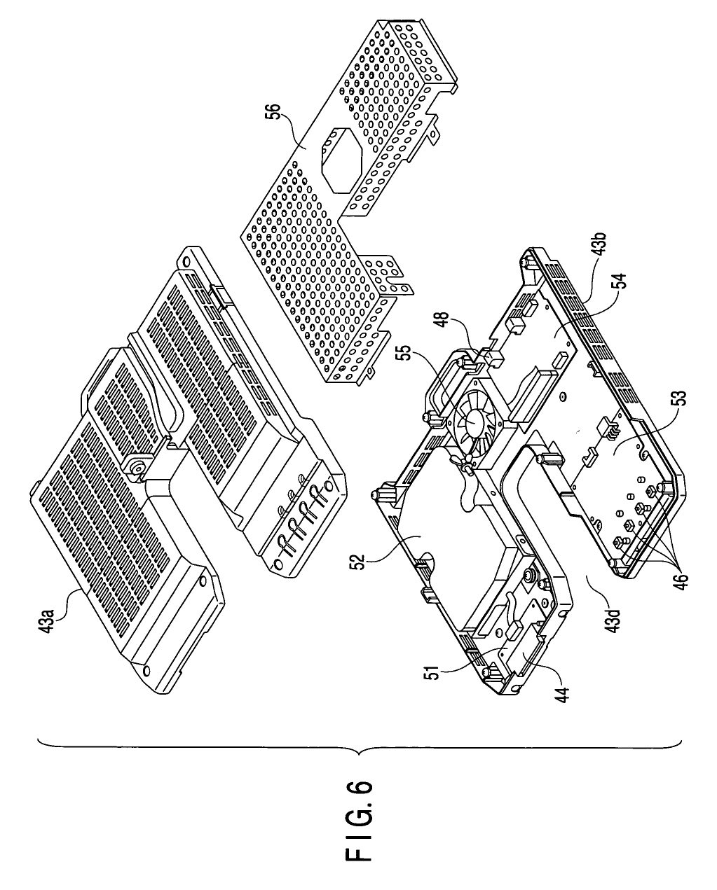

FIG. 6 shows an internal construction of the above-described HDD unit 20. That is, in the lower unit case 43b, from among both sides between which its release section 43d is sandwiched, a relay circuit board 51 connected to the connector 44 and an HDD main body 52 are housed at the side at which the above-described connector 44 is installed.

In addition, in the lower unit case 43b, from among both sides between which its release section 43d is sandwiched, an operating power circuit board 53 having the switch 46 connected thereto and a control circuit board 54 having the above-described i. Link connector 48 connected thereto are housed at the side at which there is installed the switch 46 pushed by means of the operating piece 45 of the upper unit case 43a.

Further, a cooling fan 55 is installed at the center part of the lower unit case 43b.

Then, the above-described HDD main body 52 and the control circuit board 54 are covered with a shield case 56, thereby restricting leakage of unwanted radiation in digital high speed processing. The HDD unit 20 is configured by integrating the lower unit case 43b and the upper unit case 43a with each other.

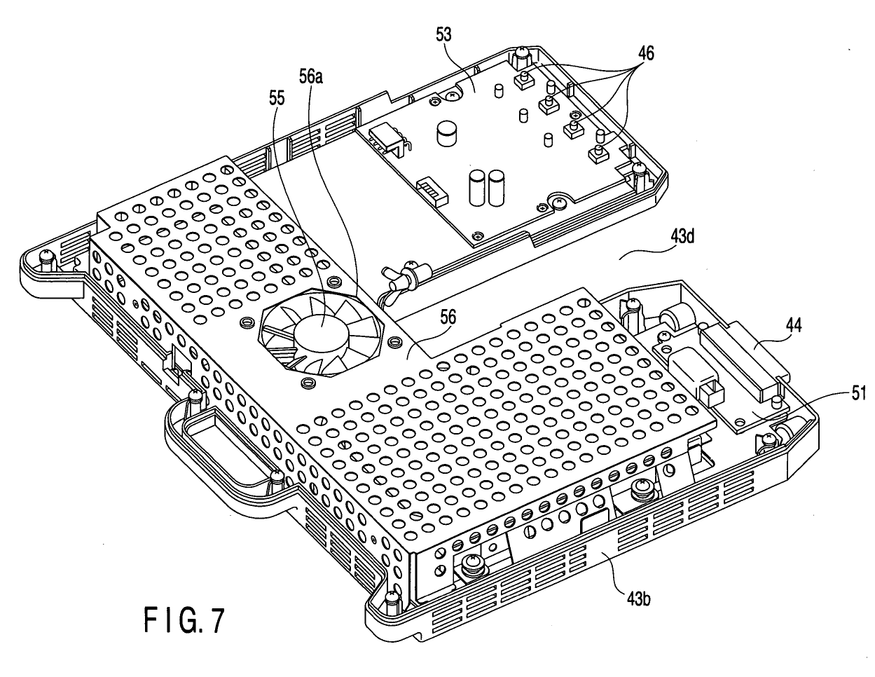

FIG. 7 shows a state in which the shield case 56 is mounted in the lower unit case 43b. An opening 56a having a diameter which is substantially equal to a diameter of the fan 55 is formed at a portion that corresponds to the fan 55 of the shield case 56 so as not to interfere air flow for heat radiation.

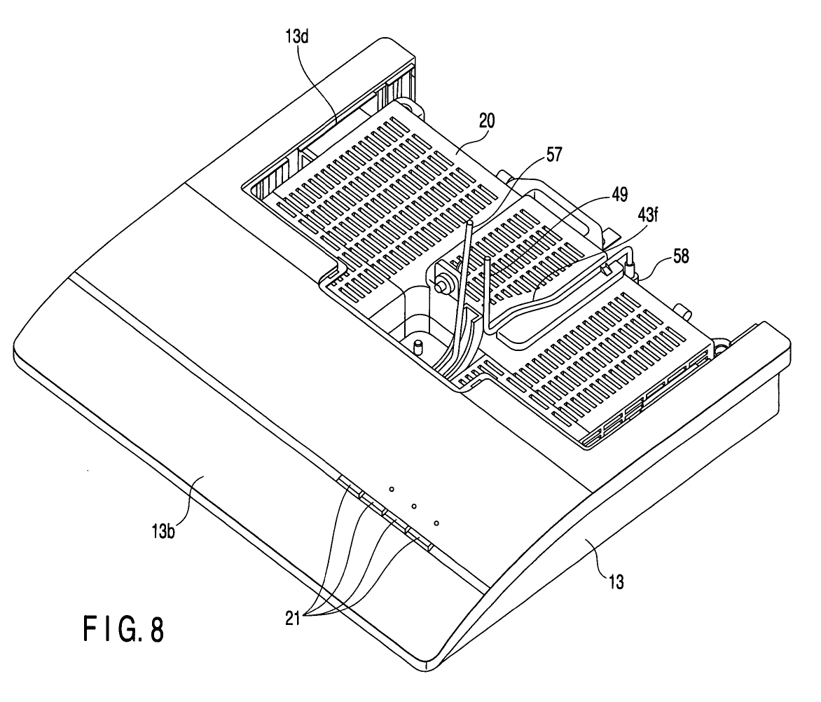

FIG. 8 shows a state in which the stand 13 having the HDD unit 20 housed therein is seen from a front side. That is, the HDD unit 20 is covered with the top plate 13d of the stand 13 from a distal end in the insert direction into the stand 13 up to its substantial center part. Then, the mount/demount port 13d of the stand 13 is closed with a capping body which is not shown, whereby the HDD unit 20 is housed in the stand 13 without being exposed.

Here, from the above-described cabinet 12, the signal line 49 described previously and a power control line 57 are extended into the housing section 42 of the stand 13 in order to achieve electrical connection with the HDD unit 20 housed in the stand 13.

Among them, the signal line 49 corresponds to the line 39 shown in FIG. 2, and is used to carry out exchange of video image and voice signals at the cabinet 12, as described previously. In this signal line 49, at its distal end, there is mounted an i. Link connector 58 for making connection with the i. Link connector 48 installed on the rear face 43e of the HDD unit 20 (corresponding to the i. Link connecting portion 40 in FIG. 2).

Then, in a state in which the HDD unit 20 is housed in the stand 13, the signal line 49 is housed and routed in the guide grove 43f formed in the upper unit case 43a. In addition, the i. Link connector 58 mounted on its distal end is connected to the i. Link connector 48 installed on the rear face 43e of the HDD unit 20. In this manner, it becomes possible to transmit video image and voice signals between the cabinet 12 and the HDD unit 20.

In addition, the above-described power control line 57 corresponds to the line 37 shown in FIG. 2, and is used for carrying out supply of power and a control signal from the cabinet 12 to the HDD unit 20.

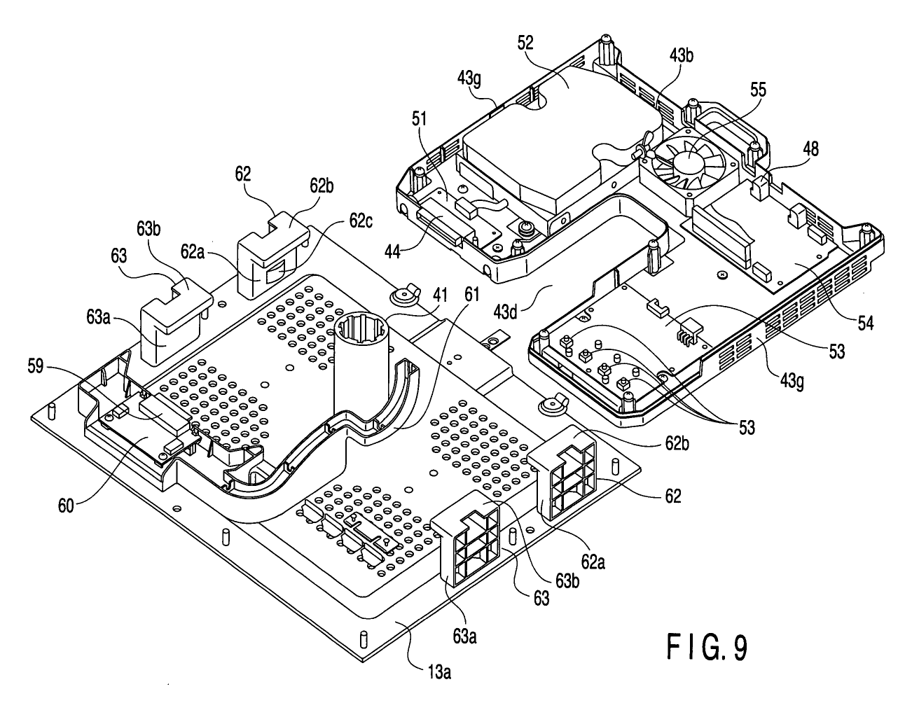

FIG. 9 shows a state in which the top plate 13b of the stand 13 has been removed. That is, in the stand 13, a connector 59 is installed at a position that corresponds to the connector 44 of the HDD unit 20 housed therein. This connector 59 corresponds to the connecting portion 38 shown in FIG. 2. When the HDD unit 20 has been housed in the stand 13, the connector 44 of the HDD unit 20 is connected.

This connector 59 is mounted on a relay circuit board 60 mounted on the bottom plate 13a of the stand 13. Then, the above-described power control line 57 extended from the cabinet 12 is connected to this relay circuit board 60. In this manner, power and a control signal can be supplied from the cabinet 12 to the HDD unit 20 via the power control line 57, the relay circuit board 60, and the connectors 59 and 44.

In this case, an installation position of the relay circuit board 60 in the stand 13 is defined at the deepest seen from the mount/demount port 13d from among the regions in the stand 13 covered with the top plate 13b, as easily presumed by referring to FIG. 8 from the position shown in FIG. 9. Thus, a user cannot touch the relay circuit board 60 easily in a state in which the HDD unit 20 has been removed from the inside of the stand 13.

In addition, at the bottom plate 13a of the stand 13, a protecting passage 61 is formed for guiding to the relay circuit board 60 the power control line 57 extended from the cabinet 12. This protecting passage 61 is formed in a groove shape such that the power control line 57 is housed and routed therein. This protecting passage 61 protects the user from touching the power control line 57 in a state in which the HDD unit 20 has been removed from the inside of the stand 13.

Here, on the bottom plate 13a of the stand 13, two pairs of guide members 62 and 63, respective ones of which are engaged with the pair of side faces 43g of the HDD unit 20 and the guide faces 43h formed thereon, are installed along the insert direction of the HDD unit 20.

These guide members 62 and 63 are installed to be opposed to each other so as to sandwich the HDD unit 20 in its widthwise direction. These guide members comprise: first guide sections 62a and 63a engaged with a side face 43g of the HDD unit 20 to carry out positional restriction in its widthwise direction; and second guide sections 62b and 63b engaged with the guide face 43h formed on the side face 43g of the HDD unit 20 to carry out positional restriction in its height direction.

In this case, the guide member 63 positioned at the depth side with respect to the mount/demount port 13d of the stand 13 is set so that its first and second guide sections 63a and 63b are brought into contact with the side face 43a and the guide face 43h of the HDD unit 20 in a substantially gapless manner.

In contrast, the guide member 62 positioned close to the mount/demount port 13d of the stand 13 is set so that its first and second guide sections 62a and 62b are formed with a slight gap with respect to the side face 43g and the guide face 43h of the HDD unit 20.

In this manner, the HDD unit 20 is easily inserted into the stand 13 and the connector 44 can be correctly connected to the connector 59 in the thus inserted state.

In addition, in the guide member 62 positioned close to the mount/demount port 13d of the stand 13, a plate spring 62c provided to be pressed against the side face 43g of the HDD unit 20 is formed at the first guide section 62a. This plate spring 62c has elasticity by cutting part of the first guide section 62a in a tongue shape, for example. In this manner, wobbling in a widthwise direction of the HDD unit 20 housed in the stand 13 can be restricted.

Further, while the HDD unit 20 is housed in the stand 13, the plate spring 43h1 (refer to FIG. 4) formed on the guide face 43h of the HDD unit is provided to be pressed against the second guide section 63b of the guide member 63. In this manner, wobbling in a height direction of the HDD unit 20 housed in the stand 13 can be restricted.

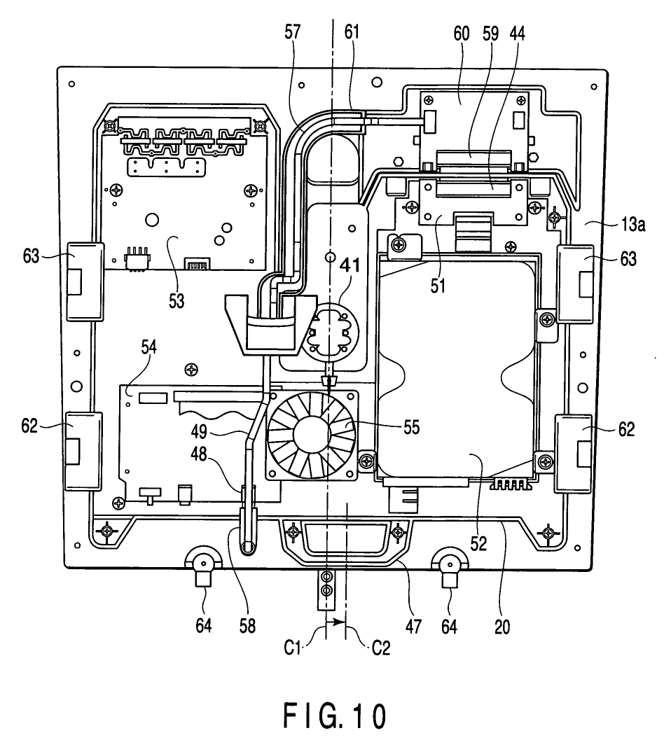

FIG. 10 shows a state of demounting the top plate 13b of the stand 13 having the HDD unit 20 housed therein. That is, it is found that the connector 44 of the HDD unit 20 is connected to the connector 59 mounted on the relay circuit board 60 in the stand 13. In addition, the power control line 57 for electrically connecting this relay circuit board 60 to the cabinet 12 is housed in the protecting passage 61 formed in the stand 13.

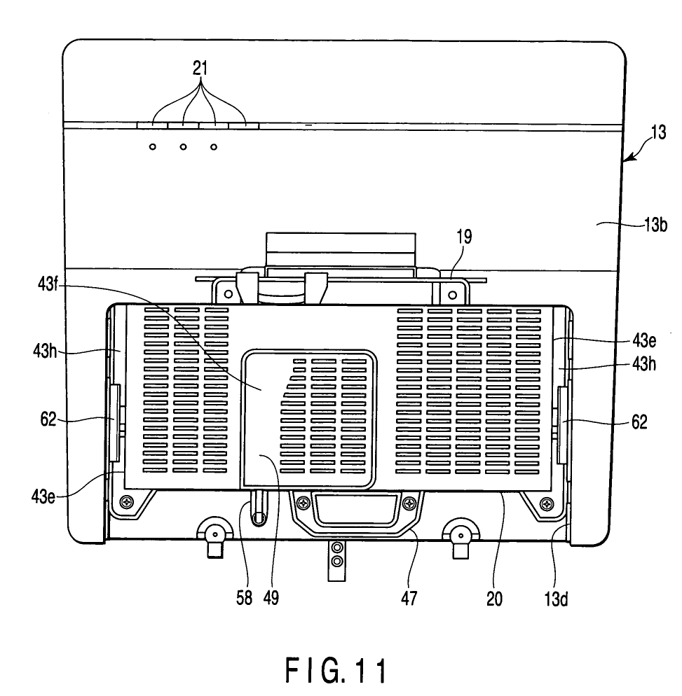

FIG. 11 shows a state in which the stand 13 having the HDD unit 20 housed therein is seen from a top side. That is, the signal line 49 for transmitting video image and voice signals between the cabinet 12 and the HDD unit 20 is housed in the guide groove 43f formed in the HDD unit 20. In addition, it is found that the i. Link connector 58 mounted on its distal end is connected to an i. Link connector 48 installed on the rear face 43e of the HDD unit 20.

In addition, it is found that the side face 43e and the guide face 43h of the HDD unit 20 is guided by the guide member 62 in the stand 13.

Here, in a state in which the HDD unit 20 is housed in the stand 13, a user pulls out the unit by holding its grip section 47, whereby the unit is demounted from the inside of the stand 13. In this case, while the user holds down and stabilizes the cabinet 12 with one hand so as to demount the HDD unit 20 by holding with the grip section 47 with the other hand, namely, so as to pull out the HDD unit 20 with one hand, a position of the grip section 47 is considered.

That is, as shown in FIG. 10, in the HDD unit 20 formed in a substantial U shape in plane, from among two portions provided together while its release section 43d is sandwiched therebetween, a portion for housing the HDD main body 52 is heavier than the other portion. Namely, a gravity position of the HDD unit 20 does not exist on a center line C1 in a widthwise direction of the HDD unit 20, and exists in location which is closer to a portion at which the HDD main body 52 is housed, rather than this center line C1.

In addition, the portion at which this HDD main body 52 is housed has the connector 44 connected to the connector 59 in the stand 13. Thus, when the HDD unit 20 is pulled out from the stand 13, a load for pulling out the connector 44 of the HDD unit 20 from the connector 59 in the stand 13 is applied to the portion at which the HDD main body 52 is housed.

Thus, at the grip section 47 for pulling the connector 44 of the HDD unit 20 from the connector 59 in the stand 13 and pulling out the HDD unit 20 from the stand 13, its center line C2 is set close to a portion at which the HDD main body 52 is housed rather than the center line C1 in the widthwise direction of the HDD unit 20, thereby making it possible to easily remove the HDD unit 20 from the inside of the stand 13 with one hand.

In addition, on the bottom plate 13a of the stand 13, at its rear side, there is installed a pair of roll-over proof bands 64 set in consideration of a gravity position of the entire television broadcast receiving apparatus 11. In this case, it is preferable that the above-described grip section 47 be set so that its center line C2 exists between the pair of roll-over proof bands 64.

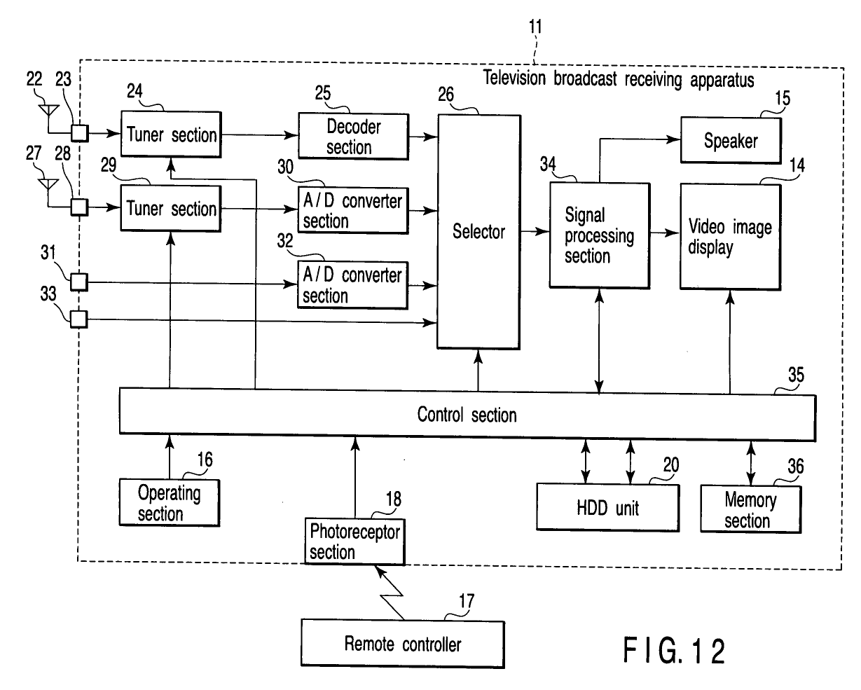

FIG. 2 describes a signal processing system of the television broadcast receiving apparatus 11 by dividing it into the cabinet 12 and the stand 13. As the signal processing system, there is no need for describing the cabinet and the stand separately in particular. As shown in FIG. 12, a description can be equivalently given such that the television broadcast receiving apparatus 11 incorporates the HDD unit 20.

According to the above-described embodiment, first, the HDD unit 20, namely, the HDD main body 52, is incorporated in the stand 13 for supporting the cabinet 12 which comprises the video image display 14 of the television broadcast receiving apparatus 11, thus making it possible to house the HDD main body 52 having a large recording capacity without losing the slimming of the cabinet 12.

In addition, by housing the HDD main body 52 in the stand 13, unwanted radiation in digital high speed processing at the HDD main body 52 hardly reaches a variety of signal processing systems in the cabinet 12, and such unwanted radiation is prevented from having an adverse effect on video image and voice reproduction. Further, by housing the HDD main body 52 in the stand 13, heat generated in the HDD main body 52 is prevented from having an adverse effect on the variety of signal processing systems in the cabinet 12.

Here, the HDD main body 52 is unitized as the HDD unit 20 by housing it in the unit case 43, and can be removably mounted in the stand 13 so that a user can easily exchange it. Thus, serviceability at the time of a failure of the HDD main body 52 can be improved. In addition, such unitization prevents the user from directly touching the HDD main body 52, and thus, is practical in terms of safety.

In this case, the HDD unit 20 is formed in a substantial U shape in plane in order to avoid a support column body 41 installed in the stand 13. Then, the guide face 43h is formed on the side face 43g of the HDD unit 20, and two pairs of guide members 62 and 63 are installed to be engaged with the side face 43g and the guide face 43h of the HDD unit 20, respectively, in the stand 13, thereby enabling easy mounting or demounting of the HDD unit 20 with respect to the stand 13.

In particular, the guide member 63 positioned at the depth side with respect to the mount/demount port 13d of the stand 13 is set so as to be brought into contact with the side face 43g and the guide face 43h of the HDD unit 20 in a substantially gapless manner. In addition, the guide member 62 positioned close to the mount/demount port 13d of the stand 13 is set so that a slight gap is formed with respect to the side face 43g and the guide face 43h of the HDD unit 20. Thus, the HDD unit 20 can be easily inserted into the stand 13, and the connector 44 can be correctly connected to the connector 59 in the thus inserted state.

In addition, the HDD unit 20 housed in the stand 13 is stably retained without any wobbling by means of the plate spring 62c formed at the guide member 62 and the plate spring 43h1 formed on the guide face 43h of the HDD unit 20.

Further, the cooling fan 55 is installed in the HDD unit 20 so that efficient heat radiation can be carried out with respect to the HDD main body 52. In particular, the fan 55 is installed at the center part of the HDD unit 20 formed in a U shape, thus making it possible to efficiently radiate the heat generated at portions on both sides between which the release section 43d has been sandwiched.

In addition, in the HDD unit 20, the HDD main body 52 and the control circuit board 54 are covered with the shield case 56, thereby making it possible to restrict leakage of unwanted radiation in digital high speed processing more significantly.

Further, power is supplied from the cabinet 12 that is a main body of the television broadcast receiving apparatus 11 to the HDD unit 20 housed in the stand 13.

In this case, the power control line 57 for carrying out supply of power and a control signal to the HDD unit 20 is housed and routed in the protecting passage 61 provided in the stand 13, whereby the control line is protected so that the user cannot touch it in a state in which the HDD unit 20 is removed from the inside of the stand 13.

In addition, the relay circuit board 60 having the power control line 57 connected thereto is installed at the deepest position viewed from the mount/demount port 13d in the stand 13 so that the user cannot easily touch the circuit board in a state in which the HDD unit 20 has been removed from the inside of the stand 13.

Further, the operator 21 for controlling the HDD unit 20 is installed in the stand 13, and the operating piece 45 is formed at a position that corresponds to the operator 21 in a state the HDD unit 20 is housed in the stand 13, so that an operating force of the operator 21 is transmitted to the switch 46 in the HDD switch 20 via the operating piece 45. In this manner, the incorporated switch 46 can be externally operated with respect to the HDD unit 20 which can be removably mounted in the stand 13.

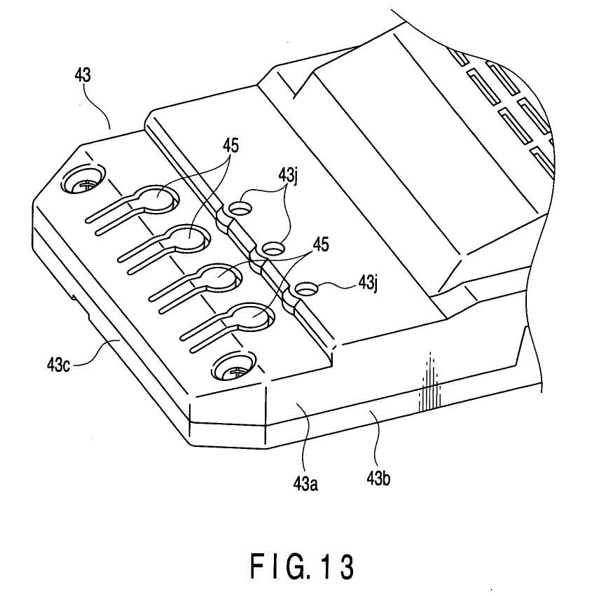

Here, a detailed description will be given with respect to a relationship among the operator 21 of the stand 13, the operating piece 45 of the HDD unit 20, and the switch 46 in the HDD unit 20. That is, FIG. 13 shows portions at which the above-described connector 44 is not installed on the front face 43c from among the two portions opposed to each other while the release section 43d of the above-described unit case 43 is sandwiched.

At these portions, in particular, at distal end portions in the insert direction into the stand 13 of the upper unit case 43a, a plurality of operating pieces 45 (four operating pieces shown) are provided along a widthwise direction of the unit case 43. These operating pieces 45 have elasticity by cutting them in a substantial U shape from the distal end to the rear end in the insert direction into the stand 13.

These operating pieces 45 each correspond to the switch 46 in the unit case 43. In addition, when the HDD unit 20 has been housed in the stand 13, a plurality of operating pieces 45 are formed at the positions that correspond to a plurality of operators 21 installed on the upper plate 13b of the stand 13.

In addition, in the above-described upper unit case 43a, through holes 43j are formed at the positions that correspond to three of the four operating pieces 45. These through holes 43j are formed at the positions that correspond to a plurality of display sections 21a installed on the top plate 13b of the stand 13 when the HDD unit 20 has been housed in the stand 13.

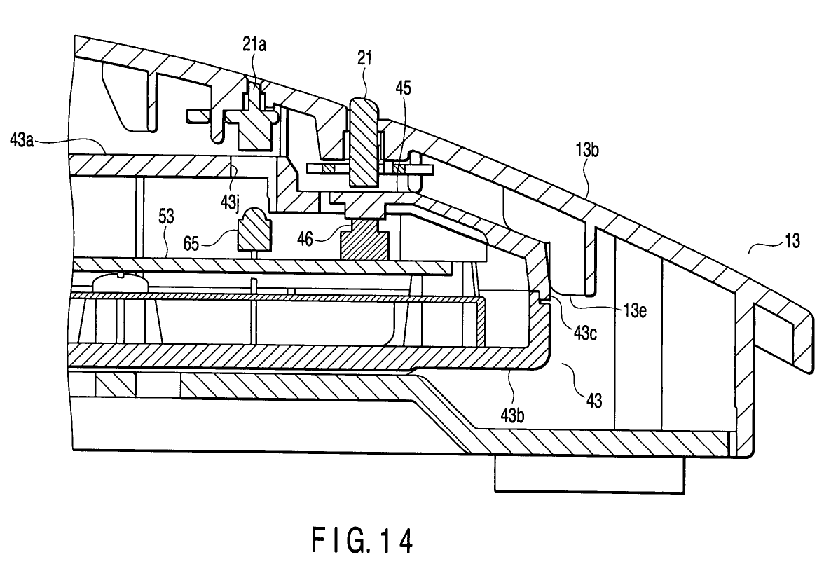

When the HDD unit 20 is housed in the stand 13, as shown in FIG. 14, the front face 43c at a portion at which the connector 44 of the unit case 43 is not installed is positioned by abutting it against a stopper 13e formed in the stand 13.

In the thus positioned state, the operating pieces 45 formed in the upper unit case 43a are opposed to a plurality of operators 21, respectively, installed on the top plate 13b of the stand 13. In respect of FIG. 14, the operating pieces 45 of the upper unit case 43a are positioned at the lower side of the operators 21 of the stand 13.

In addition, in the unit case 43, the operating pieces 45 of the upper unit case 43a and the switch 46 connected to an operating power circuit board 53 are opposed to each other. In respect of FIG. 14, the operating pieces 45 of the upper unit case 43a are positioned at the upper side of the switch 46 of the operating power circuit board 53.

Thus, when the operator 21 is operated to be pushed, that operator 21 is pushed, and the operating piece 45 is elastically deformed inwardly of the unit case 43. Then, the switch 46 installed in the unit case 43 is operated to be pushed. Namely, the operating piece 45 has a function of transmitting an operating force of the operator 21 to the switch 46.

In this manner, the operating piece 45 for transmitting the operating force of the operator 21 installed in the stand 13 to the switch 46 in the unit case 43 is provided in the upper unit case 43a of the HDD unit 20, whereby the switch 46 incorporated in the HDD unit 20 provided to be removably mounted in the stand 13 can be externally operated.

To the above-described operating power circuit board 53, for example, a display element 65 such as a light emitting diode (LED) is connected at a position that corresponds to the through hole 43j formed in the above upper unit case 43a. This display element 65 is wired so as to emit light in a state in which the switch 46 is operable, for example.

In addition, a display section 21a provided on the top plate 13b of the above stand 13 is formed of a lens or the like, for example. Thus, the light from the display element 65 passes through the through hole 43j formed in the upper unit case 43a so as to be visually checked from the outside via the display section 21a provided on the top plate 13b of the above stand 13.

Here, in the case where the stand 13 is seen from a front side, it is convenient to install the above operator 21 at the right side of the stand 13 because the user can make operation with his/her right hand. Thus, in the HDD unit 20, it is necessary to install the switch 46 at a distal end in the insert direction of a potion that corresponds to the operator 46 from among the two portions opposed to each other while the release section 43d is sandwiched therebetween.

In this manner, in the stand 13, the relay circuit board 60 is installed at the deepest position viewed from the mount/demount port 13d. In addition, in order to meet a condition that a user cannot easily touch the above circuit board, the connector 44 of the HDD unit 20 connected to the connector 59 of the relay circuit board 60 is installed at the distal end in the insert direction of a portion opposite to a portion at which the switch 46 has been installed, from among the two portions opposed to each other while the release section 43d is sandwiched therebetween.

In addition, the HDD unit 20 facilitates a user replacing work by fixing it in the stand 13 with the screw 50 which can be manually turned without using a tool or the like.

Further, transmission of video image and voice signals between the HDD unit 20 housed in the stand 13 and the cabinet 12 that is a main body of the television broadcast receiving apparatus 11 is carried out by making i. Link connection.

In this case, the signal line 49 for connecting the cabinet 12 and the HDD unit 20 to each other is housed in the guide groove 43f formed in the HDD unit 20, and the housed signal line is guided to the read face 43e of the HDD unit 20. Then, the i. Link connector 58 mounted on its distal end is connected to the i. Link connector 48 installed on the rear face 43e of the HDD unit 20.

In this manner, the work for the user to connect the i. Link connector 58 to the i. Link connector 48 of the HDD unit 20 is facilitated. In addition, the signal line 49 is housed in the guide groove 43f of the HDD unit 20, whereby the signal line 49 can be protected and the height of the stand 13 can be reduced.

Further, the grip section 47 for pulling out the HDD unit 20 from the stand 13 sets its center close to a portion at which the HDD main body 52 has been housed rather than a center line C1 in the widthwise direction of the HDD unit 20, thereby making it possible for the user to remove the HDD unit 20 from the inside of the stand 13 with one hand.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video image signal processing apparatus, comprising:
a device main body configured to have receiving sections which receive a video signal, signal processing sections which apply predetermined signal processing to the video image signal received by the receiving sections, and a video image display section which displays the video image signal to which the predetermined signal processing has been applied by the signal processing sections;
an HDD unit configured to incorporate an HDD and a push-operable operating component and to have a unit case in which an operating piece elastically deformed to enable a push operation of the operating component is formed at a position that corresponds to the operating component; and
a stand configured to be placed on a predetermined substrate for supporting the device main body so as to erect a video image display screen of the video image display section, to have a housing section which removably houses the HDD unit therein, and to have an operator enabling transmission of a video image signal between the HDD and the signal processing sections in a state in which the HDD unit has been housed in the housing section, the operator elastically deforming the operating piece at a position opposed to the operating piece of the HDD unit to make the operating component operable.

2. A video image signal processing apparatus according to claim 1, wherein the operating piece of the HDD unit is formed by cutting the unit case in a substantially U shape.

3. A video image signal processing apparatus according to claim 1, wherein the housing section of the stand comprises a positioning section which positions the housed HDD unit so that the operating piece is set at a position opposed to the operator.

4. A video image signal processing apparatus according to claim 1, wherein the operator of the stand is allocated at the right side in a state in which the stand is seen from a front side.

5. A video image signal processing apparatus according to claim 1, wherein the stand is formed in a substantially low-profile box shape, and is configured to be housed in the housing section by inserting the HDD unit from a rear side thereof; one support column body to support the device main body is erected at a center of the housing section; and
the HDD unit has a shape such that a release section greatly eliminated inwardly from a substantial center part thereof is formed at a distal end in an insert direction when the HDD unit is inserted into the housing section in order to house the HDD unit in the housing section while avoiding the support column body.

6. A video image signal processing apparatus according to claim 5, wherein the HDD unit allocates the operating piece and the operating component at a portion at which the stand is housed at a right side viewed from a font side from among two portions opposed to each other while the release section is sandwiched therebetween.

7. A video image signal processing apparatus according to claim 6, wherein the HDD unit allocates a connector to make electrical connection to the signal processing sections of the device main body at a portion at which the stand is housed at a left side viewed from a front side from among the two portions opposed to each other while the release section is sandwiched therebetween.

8. A television broadcast receiving apparatus, comprising:
a device main body configured to have receiving sections which receive a television broadcast signal, signal processing sections which apply predetermined signal processing to the television broadcast signal received by the receiving sections and restore a video image signal, and a video image display section which displays the video image signal restored by the signal processing sections;
an HDD unit configured to incorporate an HDD and a push-operable operating component and to have a unit case in which an operating piece elastically deformed to enable a push operation of the operating component is formed at a position that corresponds to the operating component; and
a stand configured to be placed on a predetermined substrate for supporting the device main body so as to erect a video image display screen of the video image display section, to have a housing section which removably houses the HDD unit therein, and to have an operator enabling transmission of a video image signal between the HDD and the signal processing sections in a state in which the HDD unit has been housed in the housing section, the operator elastically deforming the operating piece at a position opposed to the operating piece of the HDD unit to make the operating component operable.

9. A television broadcast receiving apparatus according to claim 8, wherein the operating piece of the HDD unit is formed by cutting the unit case in a substantially U shape.

10. A television broadcast receiving apparatus according to claim 8, wherein the housing section of the stand comprises a positioning section which positions the housed HDD unit so that the operating piece is set at a position opposed to the operator.

11. A television broadcast receiving apparatus according to claim 8, wherein the operator of the stand is allocated at the right side in a state in which the stand is seen from a front side.

12. A television broadcast receiving apparatus according to claim 8, wherein the stand is formed in a substantially low-profile box shape, and is configured to be housed in the housing section by inserting the HDD unit from a rear side thereof; one support column body to support the device main body is erected at a center of the housing section; and
the HDD unit has a shape such that a release section greatly eliminated inwardly from a substantial center part thereof is formed at a distal end in an insert direction when the HDD unit is inserted into the housing section in order to house the HDD unit in the housing section while avoiding the support column body.

13. A television broadcast receiving apparatus according to claim 12, wherein the HDD unit allocates the operating piece and the operating component at a portion at which the stand is housed at a right side viewed from a font side from among two portions opposed to each other while the release section is sandwiched therebetween.

14. A television broadcast receiving apparatus according to claim 13, wherein the HDD unit allocates a connector to make electrical connection to the signal processing sections of the device main body at a portion at which the stand is housed at a left side viewed from a front side from among the two portions opposed to each other while the release section is sandwiched therebetween.
